(19) United States
(12) Patent Application Publication
(10) Pub. No.: US 2007/0259140 A1
(43) Pub. Date: Nov. 8, 2007

(54) Method of Coating Labels on Containers

(75) Inventor: Bert R. Marlow, Hopewell Junction, NY (US)

Correspondence Address: BANNER & WITCOFF, LTD.;and ATTORNEYS FOR CLIENT NO. 006943, 10 SOUTH WACKER DR., SUITE 3000, CHICAGO, IL, 60606, US

(73) Assignee: Concentrate Manufacturing Company of Ireland, Hamilton (BM)

(21) Appl. No.: 11/381,296

(22) Filed: May 2, 2006

(51) Int. Cl. B28B 11/00; B32B 27/08

(52) U.S. Cl. 428/34.4; 428/35.7

(57) ABSTRACT

A method of coating a label, such as a ceramic ink label, on a container includes the use of a coating material that will serve as a barrier to prevent migration or permeation of the ink and the components of the ink from the label through the coating barrier. The coating will prevent the label from wearing, scuffing, or rubbing off as well as improve the label's resistance to repeated handling. The method also includes application of a coating that may be washed off prior to refilling and reusing the container, without affecting the underlying label or ink components of the label. The coating may also make the label more aesthetically appealing to a consumer.

### FIELD OF THE INVENTION

The invention relates generally to the coating of containers and more particularly to techniques for coating the labels on containers.

### BACKGROUND OF THE INVENTION

It is known that containers in the form of bottles are used to contain beverages such as soft drinks, juices, sports drinks, alcoholic beverages, as well as other types of materials that may be in liquid, solid or powder form. These containers typically include decorative or informative labels or graphics to identify, for example, the beverage, the producer of the beverage, or information concerning the beverage. These labels are also used to provide an aesthetically pleasing look to the container to enhance the beverage's appeal to consumers.

The known labels have been applied to containers using one of several techniques. For example, it is known to use a paper label that on one side contains an adhesive layer that will adhere the label to the container and, on the other side, a printed-on graphic, logo or information about the product. This label type, however, provides little resistance to label damage from the handling of the container or from exposure to moisture or water. And for returnable containers, this label type typically does not survive the washing procedures required before any reuse of the container, thereby requiring re-labeling of the container prior to its reuse.

Another known labeling technique includes the use of a thin Styrofoam label that covers a portion of the container with the decorative and/or informational material printed on the outer surface of the label. While this label offers some impact resistance and a relatively large surface area for printing decorative logos or product information, this label is more costly than the paper label, has little durability, and will not survive the washing procedures required of a returnable container.

Yet another known labeling technique includes printing ink directly on the container surface and, in the case of a glass container, by using a screen printing technology followed by baking the ink to the glass container. A similar technique includes preprinting an ink decal which is subsequently applied to the container surface. Both techniques permit high definition printing of various colors, graphics and product information onto the container surface. The ink used with these techniques may include, but is not limited to, inorganic paint, organic paint, ceramic ink, or the like. One of skill in the art will appreciate that some of these inks include, but are not limited to, components such as heavy metals and color pigments. The labels made using these inks are mostly durable and will generally survive the repeated washing procedures required of a returnable container. However, due to repeated handling, the ink or ink components used on the container may begin to rub off or may occasionally chip or flake off making the label less aesthetically appealing or sometimes making the product information illegible.

Certain techniques exist to improve a glass container's resistance to wear and handling. For example, it is known that glass-to-glass contact is common during the handling of glass containers. This contact creates visible scratching which may eventually result in breakage of the container. To counteract the effects of glass-to-glass contact, it is known to surface treat the glass containers at the points of contact by applying, prior to labeling, a tin oxide film that bonds to the surface of the container. Alternatively, it is known to spray the containers, prior to labeling, with a water-based solution which after evaporation of the water leaves a film to provide surface lubricity at the points of contact. The application of the tin oxide film, however, is costly, both for materials and system maintenance, while the lubricity of the water solution, though helpful to prevent surface damage, may cause problems in the subsequent labeling of the container.

Consequently, there exists a need in the art for improving the durability and integrity of the label as well as its resistance against repeated washings and handling. The present invention is directed at providing such improvements over existing labels.

### BRIEF SUMMARY OF THE INVENTION

In one exemplary embodiment, the invention is generally directed to a method of coating a label, such as an applied ceramic ink label, on a container with a material that will serve as a barrier for the label to prevent migration of the underlying ink and/or one or more components of the label through the barrier. The barrier formed by the coating will also improve the label's resistance to wearing and scuffing caused by repeated handling of the container.

In an aspect of the invention, the coating may be applied over each label or may be applied over the entire container. The coating may be a clear polymeric or acrylic layer of material that will permit visualization of the label yet provide a barrier for the label to improve the label's resistance to repeated handling and prevent the underlying label ink from permeating the barrier. The clear coating may also provide the label with a shiny, high-gloss appearance making the product more aesthetically appealing to a consumer.

In another embodiment, the coating may also wash off under a caustic wash prior to refilling and reuse of the container. The caustic wash, however, will not wash off the underlying label. By using a coating that may be washed off without washing off the underlying label, a new coating may be applied prior to each use without excessive build-up of coating on the container, resulting in a container that, in use, will have the proper amount of coating on the label to serve as the barrier for the label. In other words, the returnable container will receive a new coating over the label prior to the reuse of the container to ensure the label has the proper barrier of protection over it and to prevent migration or permeation of the underlying ink and/or one or more ink components of the label.

In yet another embodiment, the coating may be applied permanently such that it will not wash off under a caustic wash prior to refilling and reuse of the container.

Other features and advantages of the invention will become apparent to those skilled in the art upon review of the following detailed description, claims and drawings in which like numerals are used to designate like features.

### BRIEF DESCRIPTION OF THE DRAWINGS

FIG. 1 shows a schematic cross-section view of an exemplary container with an exemplary coating applied over a label on the bottle.

FIG. 2 shows a flowchart of an exemplary bottle filling and coating process.

### DETAILED DESCRIPTION OF THE INVENTION

The invention may be embodied in various forms. One embodiment includes a method of coating with a clear material all or a portion of a container having a label, such as a ceramic ink label. The coating, which is described more fully below, may be applied over any part of the label, the entire label, over one or more labels on the container, or over the entire container. The coating may be applied at any of the various stages of the container filling or refilling process. In one exemplary method, the coating may be applied to the container after it has been filled with a beverage and capped. More specifically, in the case of a container being reused, the coating may be applied to the container after it has been washed, filled and capped. After the coating stage, the container is ready to be packaged, shipped and reused.

In an aspect of the invention, a function of the coating is to serve as a barrier over the label to prevent the underlying ink or components of the ink from the label, or components of the label, from permeating or migrating through the coating. The coating will also prevent damage to the ink or label during handling or damage caused by exposure to moisture. Another aspect of the invention is that the coating may be washed off using a caustic wash, described below, after the container has been returned for refilling, without washing off the underlying label and/or the components of the label or ink. This aspect of the invention permits a new coating to be applied each time the container is returned for refilling without affecting the integrity of the underlying label. Alternatively, the coating may be permanently applied to the label such that the coating will not wash off. Additionally, the coating may be permanently applied to the label by integrating the coating with the label. One of skill in the art will appreciate that the principles of the invention have application with all containers, including but not limited to bottles, that are made of glass or are made of non-glass materials and with types of containers that may contain any type of beverage, including but not limited to any soft drink, sports drink, juice drink, alcoholic beverage, or water, or may contain any other type of material that may be in liquid, solid or powder form.

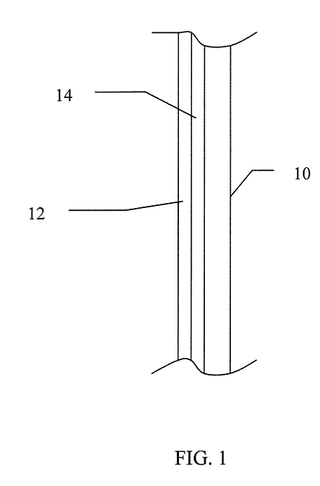

Referring to FIG. 1, there is shown a schematic cross-section view of an exemplary container 10 with an exemplary coating 12 applied over an exemplary label 14 on the container 10. The label 14 may be an applied ceramic ink label, or other label type, that is screen printed on and subsequently baked to an outer surface of the container 10. The label 14 may be, or include, any graphic, logo or information about the product or beverage and may be positioned at any location on the container.

It is contemplated that numerous possible coatings may be used with the invention. An exemplary coating 12 may include an acrylic polymer. An example of such coating and its composition is provided in Table 1, and is manufactured by Johnson Polymer of Sturtevant, Wis. This coating has been found to provide an acceptable barrier to prevent migration of the underlying ink or ink components from the label through the coating.

TABLE 1

| | |
|---|---|
| Components | Weight % |

| | |
|---|---|
| Water | 50-60% |
| Amine salt of modified acrylic polymer | 30-40% |
| Zinc ammonium carbonate | 1-3% |
| Modified wax emulsion | 1-3% |
| Ammonium hydroxide (unreacted) | <0.1% |

As can be seen from Table 1, the exemplary coating 12 includes various components having the specified approximate weight percentages. One of skill in the art will appreciate that depending on the particular coating application, the equipment used with the coating application, as well as the container type being coated, these weight percentages and constituent components may vary. For example, if a spray type applicator is used, as discussed below, it may be desirable for the coating to have a greater water concentration. Likewise, if a sponge type applicator is used, it may be desirable for the coating to have a lower water concentration. Similarly, depending on the container being coated, and the desired number of layers of coating material applied to the container, one or more of the constituent components of the exemplary coating 12 may vary. The exemplary coating 12 that is set forth in Table 1 is approved by the U.S. Food and Drug Administration for food related uses. In addition, the coating 12, once applied over the label, will not adversely affect the integrity of the label or the ink of the label.

Another exemplary coating may include a polymer based coating such as the Effectcoat™ coating, which is a spray coating manufactured by the Arkema Group. This coating, as well as other polymer based coatings, may be used with the invention without departing from the scope of the invention.

The coating may be applied to the container using one of several techniques. It is contemplated that the coating may be sprayed onto the container using known spray application techniques and equipment. For example, the container may pass across a stationary spray gun or similar device and the coating sprayed onto the container, or the label, at the desired location. If needed, the container may be rotated to properly spray all desired portions of the container or label to ensure the proper application of the coating. The bottle may then pass out of the spray application station and the next container to be coated would be indexed to the spray station and the process repeated. Alternatively, the container may be held stationary and the spray gun or similar device may be moved around the container to the desired spray location, followed by the spray gun applying the proper amount of coating. The container may then move to the next station and the next container may be indexed or transferred to the spray application station and the process repeated. Other stations that may be used with the container filling or refilling procedure, include the known inspection, washing, labeling, filling, capping and packaging stations. As indicated below, the coating may be applied to the container before or after one or more of these stations of the filling or refilling procedure, or the coating step may be incorporated into one of these stations. For example, it is contemplated that the coating may be integrated with the labeling process in that the coating and labeling may be performed at a single station or, alternatively, in a single step. In other words, it is contemplated the coating and label may be applied simultaneously where the coating is integrated with the label and then applied to the container. In one embodiment, described more fully below, the coating is applied after the bottle has gone through the filling and capping stations.

In an alternative application, the coating may be applied through the use of a sponge using conventional sponge application techniques and methods. For example, the container may pass across a sponge or sponge belt containing the coating, and the sponge or sponge belt will apply the coating to the container and/or label at the desired location. Other possible techniques include brushing, rolling, dipping and the like, all of which are considered within the scope of the invention. Each technique could be used to provide the necessary layer of coating material over the container and/or the label.

It is contemplated that the thickness of coating applied over the label may be approximately 1-5 microns. This thickness may comprise a single layer of coating or may be one or more layers overlaid on the label. In other words, the coating may be applied as a single layer from a single coating application or applied as multiple layers from multiple coating applications to achieve the desired thickness.

The coating may not only prevent the ink or components of the ink from the label and/or the label from migrating or permeating through the coating, but may also prevent these from being rubbed off the container. The coating may serve as a barrier between a consumer's hand and the underlying label, as a barrier at the points of bottle-to-bottle contact, and/or as a barrier during other handling of the container. In addition, the coating may prevent normal wear associated with handling from dulling or fading the appearance of the label and water or moisture from affecting the integrity of the label.

Once applied, the coating may be clear or semi-transparent over the label to permit the visualization of the label and may provide a glossy or matte finish to enhance the aesthetics of the label and container. In other words, one embodiment of the invention provides a method of coating the container to provide increased impact and abrasion resistance for the container, while maintaining the visual enhancement of the coated label. It should be understood that the coating may be opaque, tinted or colored and yet provide visualization of the underlying label.

The known bottles and containers are exposed to a variety of conditions, from the high temperature washing conditions to the lower temperature refrigeration conditions. The coating may be subject to these conditions and withstand the temperature, pressure and/or moisture variations expected of containers. For example, the coating will maintain its integrity and effectiveness when subject to, even during the application process, refrigeration temperatures in the range of about 35-60 degrees Fahrenheit or lower.

In another aspect of the invention, it may be desirable for the coating to be removed from the container after each use of the container. In such a situation, it may be desirable to remove the coating using a hot caustic wash that may be used with conventional washing equipment, without affecting the underlying label. For example, in an exemplary embodiment, the caustic wash may comprise about a 2-4% NaOH aqueous solution at about 55-70 degrees Celsius that is held for approximately six minutes (although time varies), followed by the rinsing of the container. Under this application, the coating may be removed without removal of the underlying label. In this situation, by removing the coating through a caustic wash, excess buildup of the coating on all or portions of the container is avoided. The container and label may then be recoated prior to reuse. One of skill in the art will appreciate that the removal method may vary depending on the type of coating used and that the removal method described above is merely exemplary of one type of method.

In another embodiment, it may be desirable for the coating on the label to withstand a specific number of washes and/or the pasteurization process before the coating must be reapplied. For example, a coating that is more durable and has greater wash-resistant properties may be used to permit the container to be reused and rewashed 10-30 times or more before the coating is reapplied. Alternatively, the caustic wash may be adjusted to still permit the proper washing of the container, without removing the coating on the container. That is, the coating may be applied permanently over the label and/or container. As should be appreciated, the degree of resistance to the washing process or the ease in which the coating may be removed may vary depending on the desired application.

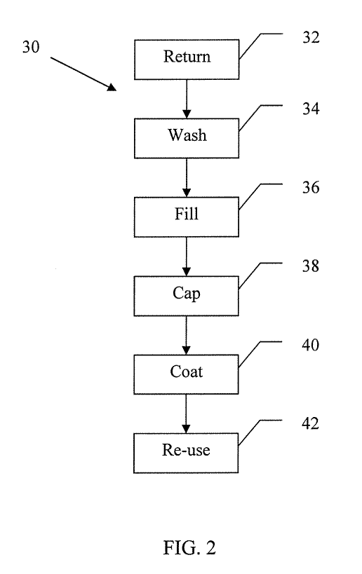

Referring to FIG. 2, there is depicted a flowchart of an exemplary container filling and coating method 30. In the exemplary method 30, the empty returnable container is returned at step 32 for cleaning and reuse. The container is then washed at step 34. At this step, if the returned container includes the coating, the coating may be washed off under the caustic wash conditions described above. The washed container will then be filled at step 36 with any desired beverage or material using any known filling technique. At step 38, the container is capped using any known capping technique. The capped container is then coated with the coating at step 40. The coating may be applied to all or a portion of the label, or over the entire container, depending on the desired application. The coating may be applied using one of the numerous application techniques described above or other suitable application techniques under varying application conditions such as temperature, pressure and moisture level. After coating, the container is packaged and shipped for reuse at step 42.

It should be understood that the method set forth in FIG. 2 demonstrates an exemplary sequence of steps of a filling and coating process. Some of the steps of FIG. 2 may be performed in other sequences and additional steps may be included into the process. As an example, it may be desirable for the coating to be applied to the container after the container has been washed but before the container has been filled with a beverage and capped. Alternatively, the coating and labeling may be applied simultaneously where the coating is integrated with the labeling step and then applied to the container. Also, one or more inspection steps may be added at any point in the process. Still other steps, and sequences of steps, are possible and are considered within the scope of the invention.

While the invention has been described with respect to specific examples including presently preferred modes of carrying out the invention, those skilled in the art will appreciate that there are numerous variations and permutations of the above described systems and techniques that fall within the spirit and scope of the invention as set forth in the appended claims.

What is claimed is:

1. A method of coating a container comprising:
providing a container having a label thereon, the label including an ink comprising one or more ink components, and
applying a coating material on at least a portion of the label, the coating forming a barrier over the portion of the label, the coating material preventing one or more ink components from the label from migrating through the barrier formed by the coating material,
the coating material being removable from the portion of the label without removing any substantial portion of the label.

2. The method of claim 1 wherein the coating material comprises a water component, an amine salt of modified acrylic polymer component, a zinc ammonium carbonate component, and a modified wax emulsion component.

3. The method of claim 1 further comprising the step of applying the coating material over the entire label.

4. The method of claim 1 further comprising the steps of filling the container with a beverage and capping the container.

5. The method of clam 4 wherein the step of applying the coating material occurs after the steps of filling the container with a beverage and capping the container.

6. The method of claim 1 wherein the label is a ceramic ink label.

7. The method of claim 1 wherein the coating material may be removed by a washing process that includes about a 2-4% NaOH aqueous solution at about 55-70 degrees Celsius to limit build up of the coating material on the container.

8. The method of claim 2 wherein the coating material comprises approximately 50-60% water, approximately 30-40% amine salt of modified acrylic polymer component, approximately 1-3% zinc ammonium carbonate component, and approximately 1-3% modified wax emulsion component, based on the weight of the coating material.

9. The method of claim 1 wherein the coating material includes an acrylic polymer.

10. The method of claim 1 wherein the step of applying a coating material includes the use of a spray applicator.

11. The method of claim 1 wherein the step of applying a coating material includes the use of a sponge applicator.

12. The method of claim 1 further comprising the step of applying the coating material over the entire container.

13. The method of claim 1 wherein the container is a bottle.

14. The method of claim 13 wherein the bottle is a glass bottle.

15. A container comprising an outer surface having an ink label thereon, a coating material applied on the ink label, the coating material forming a barrier over the label to prevent migration of one or more of the ink components from the ink label through the coating material, the coating material being removable from the container through a caustic wash without removing any substantial portion of the label, the coating material including a water component, an amine salt of modified acrylic polymer component, a zinc ammonium carbonate component, and a modified wax emulsion component.

16. The container of claim 15 wherein the container is made of glass.

17. The container of claim 15 wherein the coating material is applied over the entire label on the container.

18. The container of claim 15 wherein the coating material is applied over the entire container.

19. The container of claim 15 wherein the label is a ceramic ink label.

20. The container of claim 15 wherein the coating material may be removed from the container by a washing process that includes about a 2-4% NaOH aqueous solution at about 55-70 degrees Celsius to limit build up of the coating material on the container.

21. The container of claim 20 wherein the coating material comprises approximately 50-60% water, approximately 30-40% amine salt of modified acrylic polymer component, approximately 1-3% zinc ammonium carbonate component, and approximately 1-3% modified wax emulsion component, based on the weight of the coating material.

22. A method of preventing migration of ink comprising one or more ink components from a label that is configured on an outer surface of a container, the method comprising applying a coating material over the label to form a barrier, the coating material including a water component, an amine salt of modified acrylic polymer component, a zinc ammonium carbonate component, and a modified wax emulsion component, the barrier preventing migration of one or more ink components.

23. The method of claim 22 wherein the coating material may be removed from the container by a washing process that includes about a 2-4% NaOH aqueous solution at about 55-70 degrees Celsius to limit build up of the coating material on the container.

24. The method of claim 22 wherein the coating material includes approximately 50-60% water, approximately 30-40% amine salt of modified acrylic polymer component, approximately 1-3% zinc ammonium carbonate component, and approximately 1-3% modified wax emulsion component, based on the weight of the coating material.

25. The method of claim 22 wherein the coating material is applied over the entire label on the container.

26. The method of claim 22 wherein the coating material is applied over the entire container.

27. The method of claim 22 wherein the coating material may be removable from the container through a caustic wash without removing the ink on the container.

28. The method of claim 22 wherein the coating material is permanently applied to the container.
